(19) United States
(12) Patent Application Publication
(10) Pub. No.: US 2025/0200079 A1
(43) Pub. Date: Jun. 19, 2025

(54) METHOD AND COMPUTING DEVICE FOR FINDING LOST ITEMS

(71) Applicant: NICOVENTURES TRADING LIMITED, London (GB)

(72) Inventors: Paul TOLLERFIELD, London (GB); Sally BELL, London (GB)

(21) Appl. No.: 18/845,424

(22) PCT Filed: Mar. 14, 2023
(86) PCT No.: PCT/GB2023/050593

§ 371 Date: Sep. 9, 2024

(30) Foreign Application Priority Data
Mar. 16, 2022 (GB) 2203618.0

(51) Int. Cl. G06F 16/29; G06F 16/23

(52) U.S. Cl. CPC G06F 16/29; G06F 16/2358

(57) ABSTRACT

A computer implemented method comprises maintaining a database of locations an aerosol provision system has been lost and/or found, and predicting a location of the aerosol provision system in response to receiving an indication that the aerosol provision system is lost.

### TECHNICAL FIELD

The present invention relates to a computer implemented method and a computing device.

### BACKGROUND

Electronic aerosol provision systems such as electronic cigarettes (e-cigarettes) generally contain an aerosol-generating material, such as a reservoir of a source liquid containing a formulation, typically including nicotine, or a solid material such as a tobacco-based product, from which an aerosol is generated for inhalation by a user, for example through heat vaporisation. Thus, an aerosol provision system will typically comprise an aerosol generator, e.g. a heating element, arranged to aerosolise a portion of aerosol-generating material to generate an aerosol in an aerosol generation region of an air channel through the aerosol provision system. As a user inhales on the device and electrical power is supplied to the aerosol generator, air is drawn into the device through one or more inlet holes and along the air channel to the aerosol generation region, where the air mixes with the vaporised aerosol generator and forms a condensation aerosol. The air drawn through the aerosol generation region continues along the air channel to a mouthpiece, carrying some of the aerosol with it, and out through the mouthpiece for inhalation by the user.

It is common for aerosol provision systems to comprise a modular assembly, often having two main functional parts, namely an aerosol provision device and an article. Typically, the article will comprise the article aerosol-generating material and the aerosol generator (heating element), while the aerosol provision device part will comprise longer-life items, such as a rechargeable battery, device control circuitry and user interface features. The aerosol provision device may also be referred to as a reusable part or battery section and the article may also be referred to as a consumable, disposable/replaceable part, cartridge or cartomiser.

The aerosol provision device and article are mechanically coupled together at an interface for use, for example using a screw thread, bayonet, latched or friction fit fixing. When the aerosol-generating material in an article has been exhausted, or the user wishes to switch to a different article having a different aerosol-generating material, the article may be removed from the aerosol provision device and a replacement article may be attached to the device in its place.

As the aerosol provision system is a handheld and portable device, the user of the aerosol provision system may drop, misplace or otherwise lose the aerosol provision system. If the aerosol provision system does not have a means of determining its own location, it can be very difficult to find the aerosol provision system when it has been lost in the absence of additional information.

Various approaches are described herein which seek to help address or mitigate some of the issues discussed above.

### SUMMARY

The disclosure is defined in the appended claims.

In accordance with some embodiments described herein, there is provided a computer implemented method comprising maintaining a database of locations an aerosol provision system has been lost and/or found, and in response to receiving an indication that the aerosol provision system is lost, using the database to predict a location of the aerosol provision system.

The indication that the aerosol provision system is lost can be received via a user input or from the aerosol provision system.

The method can further comprise updating the database in response to receiving an indication the aerosol provision system was found at the location. The indication that the aerosol provision system was found at the location can be received via a user input or from the aerosol provision system. The updating can include storing the location the aerosol provision system was found and at least one of the time the aerosol provision system was found, the date the aerosol provision system was found, and the status of the aerosol provision system when it was found.

The method can further comprise in response to receiving an indication the aerosol provision system was not found at the location, updating the database and using the updated database to predict a second location of the aerosol provision system. The indication the aerosol provision system was not found at the location can be received via a user input or from the aerosol provision system.

The database can also comprise at least one of a time and a date the aerosol provision system was lost and/or found. The database can also comprise a status of the aerosol provision system when it was lost and/or found. The status can comprise one or more of an amount of charge of a power source of the aerosol provision system, an orientation of the aerosol provision system, and a temperature of an aerosol generator of the aerosol provision system.

There is also provided a computer readable storage medium comprising instructions which, when executed by a processor, performs the above method.

In accordance with some embodiments described herein, there is provided a computing device comprising one or more processors, and memory configured to store instruction that, when executed by the one or more processors cause the one or more processors to perform the above method.

These aspects and other aspects will be apparent from the following detailed description. In this regard, particular sections of the description are not to be read in isolation from other sections.

### BRIEF DESCRIPTION OF DRAWINGS

Embodiments of the invention will now be described, by way of example only, with reference to accompanying drawings, in which:

FIG. 1 is a schematic diagram of an aerosol provision system;

FIG. 2 is a schematic diagram of a system comprising an aerosol provision system;

FIG. 3 is a flow diagram of a method for predicting the location of an aerosol provision system;

FIG. 4 is a flow diagram of a method for predicting the location of an aerosol provision system.

### DETAILED DESCRIPTION

Aspects and features of certain examples and embodiments are discussed/described herein. Some aspects and features of certain examples and embodiments may be implemented conventionally and these are not discussed/described in detail in the interests of brevity. It will thus be appreciated that aspects and features of articles and systems discussed herein which are not described in detail may be implemented in accordance with any conventional techniques for implementing such aspects and features.

The present disclosure relates to aerosol provision systems, which may also be referred to as vapour provision systems, such as e-cigarettes. Throughout the following description the term “e-cigarette” or “electronic cigarette” may sometimes be used, but it will be appreciated this term may be used interchangeably with aerosol provision system and electronic aerosol provision system.

As noted above, aerosol provision systems (e-cigarettes) often comprise a modular assembly including both a reusable part (aerosol provision device) and a replaceable (disposable) or refillable cartridge part, referred to as an article. Systems conforming to this type of two-part modular configuration may generally be referred to as two-part systems or devices. It is also common for electronic cigarettes to have a generally elongate shape. For the sake of providing a concrete example, certain embodiments of the disclosure described herein comprise this kind of generally elongate two-part system employing refillable cartridges. However, it will be appreciated the underlying principles described herein may equally be adopted for other electronic cigarette configurations, for example modular systems comprising more than two parts, as devices conforming to other overall shapes, for up example based on so-called box-mod high performance devices that typically have a more boxy shape, or even systems comprising one part where the aerosol provision device and article are integrally formed with one another.

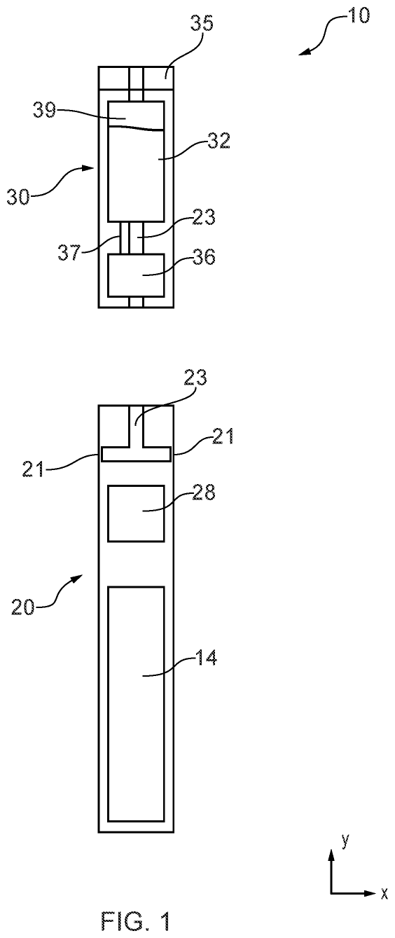

FIG. 1 is a highly schematic diagram (not to scale) of an example aerosol provision system 10, such as an e-cigarette, to which embodiments are applicable. The aerosol provision system 10 has a generally cylindrical shape, extending along a longitudinal or y axis as indicated by the axes (although aspects of the invention are applicable to e-cigarettes configured in other shapes and arrangements), and comprises two main components, namely an aerosol provision device 20 and an article 30.

The article 30 comprises or consists of aerosol-generating material 32, part or all of which is intended to be consumed during use by a user. An article 30 may comprise one or more other components, such as an aerosol-generating material storage area 39, an aerosol-generating material transfer component 37, an aerosol generation area, a housing, a wrapper, a mouthpiece 35, a filter and/or an aerosol-modifying agent.

An article 30 may also comprise an aerosol generator 36, such as a heating element, that emits heat to cause the aerosol-generating material 32 to generate aerosol in use. The aerosol generator 36 may, for example, comprise combustible material, a material heatable by electrical conduction, or a susceptor. It should be noted that it is possible for the aerosol generator 36 to be part of the aerosol provision device 20 and the article 30 then may comprise the aerosol-generating material storage area 39 for the aerosol-generating material 32 such that, when the article 30 is coupled with the aerosol provision device 20, the aerosol-generating material 32 can be transferred to the aerosol generator 36 in the aerosol provision device 20. It should be appreciated that the aerosol generator 36 may encompass an aerosol generator other than a heater. More generally, an aerosol generator is an apparatus configured to cause aerosol to be generated from the aerosol-generating material. In some other embodiments, the aerosol generator is configured to cause an aerosol to be generated from the aerosol-generating material without heating. For example, the aerosol generator may be configured to subject the aerosol-generating material to one or more of vibration, increased pressure, or electrostatic energy.

Aerosol-generating material is a material that is capable of generating aerosol, for example when heated, irradiated or energized in any other way. The aerosol-generating material 32 may, for example, be in the form of a solid, liquid or gel which may or may not contain an active substance and/or flavourants. In some embodiments, the aerosol-generating material 32 may comprise an “amorphous solid”, which may alternatively be referred to as a “monolithic solid” (i.e. non-fibrous). In some embodiments, the amorphous solid may be a dried gel. The amorphous solid is a solid material that may retain some fluid, such as liquid, within it. In some embodiments, the aerosol-generating material 32 may for example comprise from about 50 wt %, 60 wt % or 70 wt % of amorphous solid, to about 90 wt %, 95 wt % or 100 wt % of amorphous solid.

The aerosol-generating material comprises one or more ingredients, such as one or more active substances and/or flavourants, one or more aerosol-former materials, and optionally one or more other functional materials such as pH regulators, colouring agents, preservatives, binders, fillers, stabilizers, and/or antioxidants.

The active substance as used herein may be a physiologically active material, which is a material intended to achieve or enhance a physiological response. The active substance may for example be selected from nutraceuticals, nootropics, and psychoactives. The active substance may be naturally occurring or synthetically obtained. The active substance may comprise for example nicotine, caffeine, taurine, theine, vitamins such as B6 or B12 or C, melatonin, cannabinoids, or constituents, derivatives, or combinations thereof. The active substance may comprise one or more constituents, derivatives or extracts of tobacco, cannabis or another botanical.

In some embodiments, the active substance comprises nicotine. In some embodiments, the active substance comprises caffeine, melatonin or vitamin B12. The aerosol provision device 20 includes a power source 14, such as a battery, configured to supply electrical power to the aerosol generator 36. The power source 14 in this example is rechargeable and may be of a conventional type, for example of the kind normally used in electronic cigarettes and other applications requiring provision of relatively high currents over relatively short periods. The power source 14 may be recharged through the charging port (not illustrated), which may, for example, comprise a USB connector.

The aerosol provision device 20 includes device control circuitry 28 configured to control the operation of the aerosol provision system 10 and provide conventional operating functions in line with the established techniques for controlling aerosol provision systems such as electronic cigarettes. The device control circuitry (processor circuitry) 28 may be considered to logically comprise various sub-units/circuitry elements associated with different aspects of the electronic cigarette's operation. For example, depending on the functionality provided in different implementations, the device control circuitry 28 may comprise power source control circuitry for controlling the supply of electrical power from the power source 14 to the aerosol generator 36, user programming circuitry for establishing configuration settings (e.g. user-defined power settings) in response to user input, as well as other functional units/circuitry associated functionality in accordance with the principles described herein and conventional operating aspects of electronic cigarettes. It will be appreciated the functionality of the device control circuitry 28 can be provided in various different ways, for example using one or more suitably programmed programmable computer(s) and/or one or more suitably configured application-specific integrated circuit(s)/circuitry/chip(s)/chipset(s) configured to provide the desired functionality.

The aerosol provision device 20 has an interface configured to receive the article 30, thereby facilitating the coupling between the aerosol provision device 20 and the article 30. The interface is located on a surface of the aerosol provision device 20.

The housing of the article 30 has a surface configured to be received by the interface on the aerosol provision device 20 in order to facilitate coupling between the article 30 and the aerosol provision device 20. The surface of the article may be configured to be a size and/or shape that mirrors the size and/or shape of the interface in order to facilitate coupling between the aerosol provision device 20 and the article 30. For example, the interface may comprise a cavity, chamber or other space on the surface of the aerosol provision device 20. The surface of the article 30 can then be configured to be a size and shape that mirrors the size and shape of the cavity in order for the surface of the article 30 to be inserted into the cavity.

Although not illustrated, the interface of the aerosol provision device 20 and the surface of the article 30 may have complementary features to reversibly attach and mate the article 30 to the aerosol provision device 20, such as a screw thread, bayonet fitting, latched or friction fit fixing or other fastening means.

The interface also comprises one or more connectors, such as contact electrodes, connected via electrical wiring to the control circuitry 28 and the power source 14. The article 30 also comprises one or more connectors, such as contact electrodes, connected via electrical wiring to the aerosol generator 36. In use, the article 30 is received by the interface of the aerosol provision device 20, thereby coupling the aerosol provision device 20 and the article 30. This results in the connectors on the article 30 mating with the connectors on the aerosol provision device 20, thereby allowing electrical power and electrical current to be supplied from the power source 14 of the aerosol provision device 20 to the aerosol generator 36 of the article 30.

The housing of the article 30 has a surface configured to engage with an interface on the aerosol provision device 20 in order to facilitate coupling between the article 30 and the aerosol provision device 20. In other words, the aerosol provision device 20 is configured to receive the article 30, via the interface, and the surface of the article is proximate to the interface on the aerosol provision device 20 when the article 20 is received by the interface.

The aerosol provision system 10 includes one or more air inlets (not illustrated), located on one or more of the aerosol provision device 20 and the article 30. In use, as a user inhales on the mouthpiece 35, air is drawn into the aerosol provision system 10 through the air inlets and along an air channel 23 to the aerosol generator 36, where the air mixes with the vaporised aerosol-generating material 32 and forms a condensation aerosol. The air drawn through the aerosol generator 36 continues along the air channel 23 to a mouthpiece 35, carrying some of the aerosol with it, and out through the mouthpiece 35 for inhalation by the user.

By way of a concrete example, the article 30 comprises a housing (formed, e.g., from a plastics material), an aerosol-generating material storage area 39 formed within the housing for containing the aerosol-generating material 32 (which in this example may be a liquid which may or may not contain nicotine), an aerosol-generating material transfer component 37 (which in this example is a wick formed of e.g., glass or cotton fibres, or a ceramic material configured to transport the liquid from the reservoir using capillary action), an aerosol-generating area containing the aerosol generator 36, and a mouthpiece 35. Although not shown, a filter and/or aerosol modifying agent (such as a flavour imparting material) may be located in, or in proximity to, the mouthpiece 35. The aerosol generator 36 of this example comprises a heater element formed from an electrically resistive material (such as NiCr8020) spirally wrapped around the aerosol-generating material transfer component 37, and located in an air channel 23. The area around the heating element and wick combination is the aerosol-generating area of the article 30.

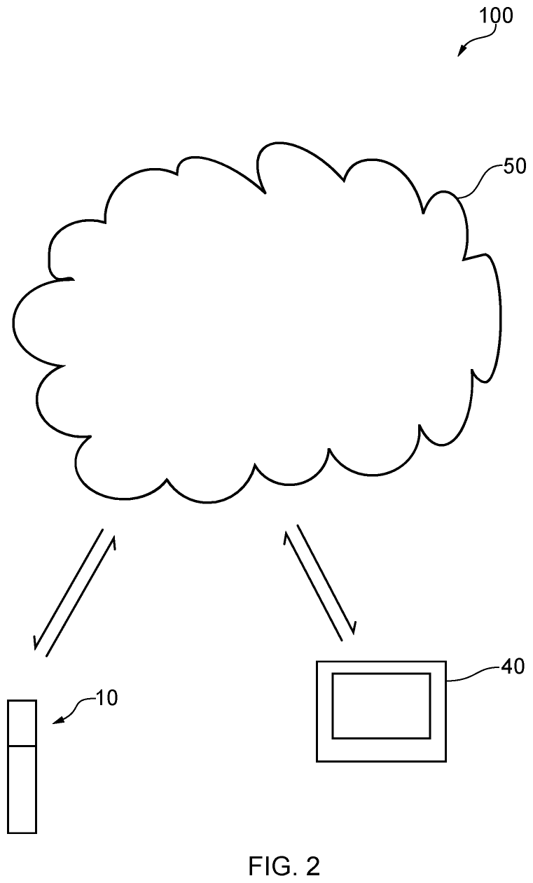

FIG. 2 is a schematic diagram of a system 100 comprising an aerosol provision system 10, where the same reference signs have been used to denote same components in FIGS. 1 and 2. System 100 comprises an aerosol provision system 10, a computing device 40 and a network 50. Computing device 40 can be a device associated with the aerosol provision system 10, for example a mobile device, handheld computing device, or other electronic device. Computing device 40 is configured to communicate with the aerosol provision system 10 via the network 50. For example, computing device 40 can comprise a communications interface configured to communicate with the device control circuitry 28 of the aerosol provision device 20 via the network. The computing device 40 and the aerosol provision system 10 can communicate using a suitable wireless communications protocol such as Wi-Fi, Bluetooth, RFID, NFC.

The computer device 40 may be associated with a user of the aerosol provision system 10 such that the aerosol provision system 10 and the computer device 40 may be associated with one another, for example via a user profile of the user of aerosol provision system 10.

Since the aerosol provision system 10 is a portable electronic device, the user may lose or misplace the aerosol provision system 10 and require assistance in relocating it. The aerosol provision system 10 may not have a means of determining its location, for example, the aerosol provision system 10 may not have a GPS interface. Alternatively, the aerosol provision system 10 may be situated in a location where it is not possible to determine its location, for example in a building or underground. The computing device 40 can therefore assist the user in locating the aerosol provision system 10.

The computer device 40 is configured to maintain a database of locations the aerosol provision system 10 has been previously lost and/or found. The computing device 40 is then configured to use the database to predict a location of the aerosol provision system 10.

Each time the aerosol provision system 10 is lost and/or found, the computing device 40 can update the database to store the location the aerosol provision system 10 was lost and/or found. For example, the computing device 40 can receive an indication that the aerosol provision system 10 was found at a particular location and the database can be updated to store this location.

In this regard, the conditions for determining when an aerosol provision system 10 is lost and/or found may be based on a number of factors.

In some implementations, the aerosol provision system 10 may be automatically determined as lost and/or found. For example, whether the aerosol provision system 10 is lost and/or found may be based on the presence/absence or strength of a communicative connection between the aerosol provision device 10 and the computer device 40. For instance, when the aerosol provision system 10 and computing device 40 communicate via Bluetooth, when the aerosol provision device 10 is within a certain distance of the computing device, for example 5, 10 or 20 m, the computing device 40 may consider the aerosol provision system 10 to be found, and conversely when the aerosol provision system 10 is greater than this certain distance from the computing device 40, the computing device 40 may consider the aerosol provision system to be lost. The certain distance may correspond to the broadcast range of the communication protocol used by the aerosol provision system 10 and the computing device 40, such that the aerosol provision system 10 is considered to found when the aerosol provision system 10 and the computing device 40 are able to communicate with one another (and conversely, the aerosol provision system 10 is considered lost when the aerosol provision 10 and the computing device 40 are not able to communicate). Other factors may also be used to determine whether the device is lost and/or found, e.g., the time for which a communicative connection has been lost, the movement of the system as sensed by an accelerometer, the use of the device for generating aerosol, etc.

In other implementations, the aerosol provision system 10 may be manually determined as lost and/or found. For example, the computing device 40 may include or provide a user input mechanism that allows a user to input whether the system 10 is lost and/or found. A user may realise they cannot find their system 10 and subsequently input into the computing device 40 that their system 10 is lost. Subsequently, when a user finds their system 10, the user subsequently inputs into the computing device 40 that their system 10 has been found.

The location the aerosol provision system 10 has been lost and/or found may be determined and recorded at a high or low granularity depending on the context. For example, the computing device 40 may record the GPS coordinates the aerosol provision system 10 was located at, and/or the location may be categorised based on its proximity to a known location. For example, the user is likely to be in a residential property (home) in the evenings and overnight, and therefore any location within a particular range of the residential property (i.e. within 10, 50, or 100 m) may be recorded in the database as corresponding to the location of the residential property. Alternatively, the location may be recorded with greater granularity. For example, the location may be recorded as a particular room in a building, for example lounge, bedroom, office, or a location within a room, such as sofa, bedside table, desk. When the computing device 40 receives a notification to indicate that the aerosol provision system 10 has been located, the computing device can be configured to request a classification or description of the location the aerosol provision system 10 was located from the user, for example by displaying a message on a display device of the computing device 40 or playing a sound through a speaker of the computer device 40, or eliminating a light of the computing device 40. The user is then able to provide the classification or description of the location, or select an existing classification or description to apply to the location the aerosol provision system 10 was found. The user can provide the classification or description via one or more input devices of the computer system 40, such as a keyboard, mouse, button or touchscreen. The classification or description could be a building, such as home, work for a particular shop, or a room within a building, such as lounge, bedroom or office, or a landmark, feature or object, such as a park, a beach, an outdoor square, sofa or bedside table. More than one classification may be applied to a location, such as a desk at the office, a sofa in the lounge at home, or a bench in a park. The database can also comprise additional information related to the location the device was lost and/or found, for example a time, date, and/or day of the week the aerosol provision system 10 was lost and/or found. The time, date and day of the week can be determined by the computing device 40 in response to receiving the indication that the aerosol provision system 10 was found.

The additional information can also comprise a status of the aerosol provision system 10 when it was lost and/or found, such as one or more of an amount of charge of a power source 14 of the aerosol provision system 10, an orientation of the aerosol provision system 10, and a temperature of an aerosol generator 36 of the aerosol provision system. The computing device 40 is configured to send a request to the aerosol provision system 10, for example via the network 50, in response to receiving the indication that the aerosol provision system 10 was found, and the aerosol provision system 10 can send the status of the aerosol provision system 10 to the computing device 40 in response to receiving the request.

The additional information can then be stored in the database along with the location the aerosol provision system 10 was found.

By maintaining a database of locations the aerosol provision system 10 has been lost and/or found in the manner set out above, the computing device 40 determines one or more patterns of behaviour related to the locations where the aerosol provision system 10 has been lost and/or found. The database entries may indicate that the aerosol provision system 10 is found at the same location at particular times of the day or days of the week indicating a pattern of behaviour or movement of the user. For example, the user of the aerosol provision system 10 may work in an office, factory or other location of employment with a regular working pattern, such as weekdays between 9 AM and 5 PM. The computing device 40 may therefore determine from the database entries that the aerosol provision system 10 is likely to be located at the location of employment within these times. Equally, most users are likely to be in a residential property in the evenings and overnight, and therefore the aerosol provision system 10 is likely to be located at the residential property at these times. The user may only be allowed to use the aerosol provision system 10 in certain locations, for example outside, due to legislation requirements. The temperature of the aerosol generator 36 of the aerosol provision system 10 is therefore likely to be high (or substantially above the ambient temperature) in locations where the user frequently uses the aerosol provision system 10, or locations where the user is permitted to use the aerosol provision system 10. Equally, the user may only charge the power source 14 of the aerosol provision system 10 in particular locations and/or at particular times of the day and/or week. The amount of charge of the power source of the aerosol provision system 10 can therefore indicate how recently the aerosol provision system 10 is likely to have been located at one of the locations where the user charges the aerosol provision system 10. The orientation of the aerosol provision system 10 can be correlated with the location where the aerosol provision system 10 was found. For example, when the aerosol provision system 10 is located on a desk, bedside table or other flat surface the aerosol provision system 10 will be orientated in the plane of the flat surface. When the aerosol provision system 10 has been dropped or fallen somewhere, for example down the side of a sofa, into a bin or into a person's pocket, the aerosol provision system 10 is likely to be in a different orientation, for example with the article 30 facing substantially downwards.

The computing device 40 is configured to predict the location of the aerosol provision system 10 in response to receiving an indication that the aerosol provision system 10 is lost. The indication can be received via a user input, for example via an input device of the computing device 40, such as a mouse, keyboard, button or touchscreen. Alternatively, the indication can be received from the aerosol provision system 10, for example via the network 50. In this case, the aerosol provision system 10 is configured to determine that it is lost and transmit the indication to the computing device 40.

Having predicted the location of the aerosol provision system 10, the computing device 40 can provide an indication of the predicted location of the aerosol provision system 10 to the user, for example by displaying a message on a display device of the computing device 40 or playing a sound through a speaker of the computer device 40, or eliminating a light of the computing device 40. The user can then go to the predicted location to see if they can find the aerosol provision system 10 there.

The user is then able to provide an indication to the computing device 40 as to whether the aerosol provision system 10 was found at the predicted location (i.e. the location predicted by the computer device 40), for example via an input device of the computing device 40, such as a mouse, keyboard, button or touchscreen. Alternatively, the indication can be provided to the computing device 40 by the aerosol provision system 10, for example via the network 50. In this case, the user may provide an input on the aerosol provision system 10, such as inputting a password or locking the aerosol provision system 10, thereby indicating that they are the owner of the aerosol provision system 10. The aerosol provision system 10 is then configured to send an indication to the computing device 40 in response to receiving such an input, where the indication indicates that the aerosol provision system 10 was found at the predicted location (since the user has interacted with the aerosol provision system 10). The aerosol provision system 10 can also be configured to send an indication to the computer device 40 indicating that the aerosol provision system 10 was not found the predicted location. For example, the computing device 40 may determine that the computing device 40 is located at the predicted location (e.g. taken or carried there by the user) but that the aerosol provision system 10 is not within Bluetooth, NFC or other short range communication protocol communication range of the computing device 40. The computing device 40 can then send a request to the aerosol provision system 10 via a different communication protocol, such as Wi-Fi via network 50, and the aerosol provision system 10 send the indication in response.

If the indication received either via user input or from the aerosol provision system 10 indicates that the aerosol provision system 10 was found at the predicted location, the computing device 40 is configured to update the database. For example, as described above, the updating can include storing the location where the aerosol provision system 10 was found (i.e. the predicted location) and at least one of the time the aerosol provision system was found, the date and/or day of the week the aerosol provision system 10 was found, the status of the aerosol provision system 10 when it was found, and a classification or description of the location the aerosol provision system and was found. The classification or description may be known from the database, or the computing device 40 may be configured to request a classification or description from the user as described above.

If the indication received either by user input or from the aerosol provision system 10 indicates that the aerosol provision system 10 was not found at the location, the computing device 40 is configured to update the database. In other words, in response to receiving an indication the aerosol provision system was not found at the location, the computing device 40 update the database. The computing device 40 is then configured to use the updated database to predict a second location of the aerosol provision system 10. For example, when predicting the first location of the aerosol provision system 10, the computing device 40 could determine a ranked list of locations the aerosol provision system 10 may be located at, with the first location in the ranks list corresponding to the most likely location that the aerosol provision system 10 is located at. The computing device 40 is then configured to use the first location in the ranked list as the first predicted location of the aerosol provision system 10. In response to receiving the indication that the aerosol provision system 10 was not found that the first predicted location, the computing device 10 can then use the second location in the ranked list as the second predicted location. Alternatively, the computing device 40 can use the updated database to make a new prediction for the location of the aerosol provision system 10, and use this new prediction as the second predicted location.

As set out above with the first predicted location, the computing device 40 can be configured to provide an indication of the second predicted location to the user, for example by displaying a message on display screen of the computing device 40. The user or the aerosol provision system 10 can then provide an indication to the computing device 40 as to whether the aerosol provision system 10 was found at the second predicted location or not. The computing device 40 is then configured to update the database in response to receiving the indication from the user or the aerosol provision system 10, and can provide a further prediction of the location of the aerosol provision system 10 as set out above in the event that the aerosol provision system 10 was not found at the second predicted location. This process can then be repeated until the aerosol provision system 10 is located.

By updating the database each time the aerosol provision system 10 is found at a predicted location and each time the aerosol provision system is not found at a predicted location, the computing device 40 maintains the database of locations for use in predicting the location of the aerosol provision device 10 next time the aerosol provision device 10 is lost.

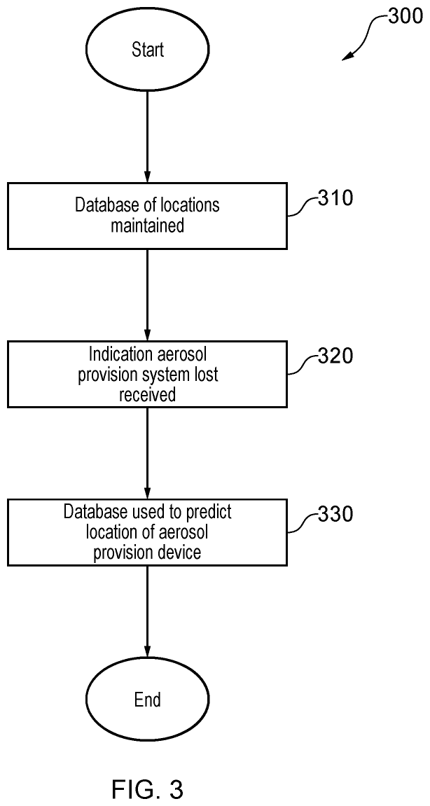

FIG. 3 is a flow diagram of a method 300 for predicting the location of an aerosol provision system, such as aerosol provision system 10. The method begins at step 310, where a database of locations an aerosol provision system 10 has been lost and/or found is maintained. At step 320, the database is used to predict a location of the aerosol provision system 10 in response to receiving an indication that the aerosol provision system is lost. The method then ends.

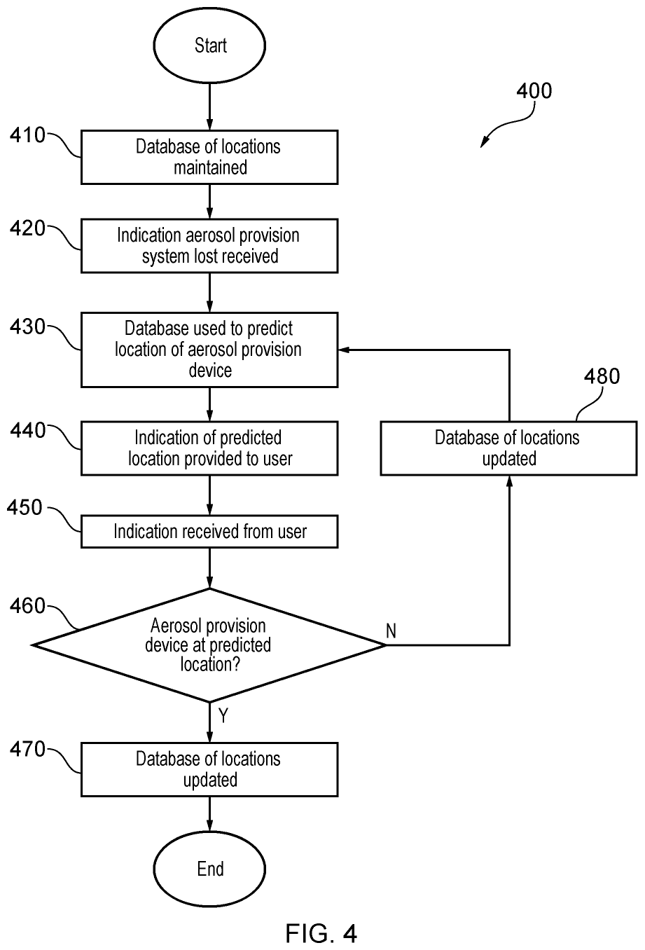

FIG. 4 is a further flow diagram of a method 400 for predicting the location of an aerosol provision system, such as aerosol provision system 10. The method begins at step 410, where a database of locations an aerosol provision system 10 has been lost and/or found is maintained. At step 420, an indication is received that the aerosol provision system 10 is lost. As set out above the indication can be received via a user input or from the aerosol provision system 10. At step 430, a location of the aerosol provision system is predicted using the database, and at step 440 an indication of the predicted location is provided to the user. At step 450, an indication is received, for example via a user input or from the aerosol provision system 10. At step 460, if received indication indicates that the aerosol provision system 10 was found at the predicted location, the method proceeds to step 470, where the database is updated. The method then ends. If at step 460, however, the received indication indicates that the aerosol provision system 10 was not found at the predicted location, the method proceeds to step 480 where the database is updated. A method then returns to step 430, where a (second) location of the aerosol provision system 10 is predicted using the (updated) database.

The methods 300 and 400 illustrated in FIGS. 3 and 4 may be stored as instructions on a computer readable storage medium, such that when the instructions are executed by a processor, the method described above is performed. The computer readable storage medium may be non-transitory. In other words, the methods 300 and 400 illustrated in FIGS. 3 and 4 may be computer implemented. The methods 300 and 400 may be performed by aerosol provision device or a related device (e.g. smart phone), such as the computing device 40.

As described above, the present disclosure relates to (but it not limited to) a computer implemented method comprising maintaining a database of locations an aerosol provision system has been lost and/or found, and, in response to receiving an indication that the aerosol provision system is lost, using the database to predict a location of the aerosol provision system.

Thus, there has been described a computer implemented method and a computing device.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in future.

1. A computer implemented method comprising:
maintaining a database of locations an aerosol provision system has been lost and/or found; and
in response to receiving an indication that the aerosol provision system is lost, using the database to predict a location of the aerosol provision system.

2. The method of claim 1, wherein the indication that the aerosol provision system is lost is received via a user input.

3. The method of claim 1, wherein the indication that the aerosol provision system is lost is received from the aerosol provision system.

4. The method of claim 1, further comprising updating the database in response to receiving an indication the aerosol provision system was found at the location.

5. The method of claim 4, wherein the indication that the aerosol provision system was found at the location is received via a user input.

6. The method of claim 4, wherein the indication that the aerosol provision system was found at the location is received from the aerosol provision system.

7. The method of claim 4, wherein the updating includes storing the location the aerosol provision system was found and at least one of the time the aerosol provision system was found, the date the aerosol provision system was found, and the status of the aerosol provision system when it was found.

8. The method of claim 1, further comprising:
in response to receiving an indication the aerosol provision system was not found at the location, updating the database and using the updated database to predict a second location of the aerosol provision system.

9. The method of claim 8, wherein the indication the aerosol provision system was not found at the location is received via a user input.

10. The method of claim 8, wherein the indication the aerosol provision system was not found at the location is received from the aerosol provision system.

11. The method of claim 1, wherein the database also comprises at least one of a time and a date the aerosol provision system was lost and/or found.

12. The method of claim 1, wherein the database also comprises a status of the aerosol provision system when it was lost and/or found.

13. The method of claim 12, wherein the status comprises one or more of an amount of charge of a power source of the aerosol provision system, an orientation of the aerosol provision system, and a temperature of an aerosol generator of the aerosol provision system.

14. A non-transitory computer readable storage medium comprising instructions which, when executed, perform a method comprising:
maintaining a database of locations an aerosol provision system has been lost and/or found; and
in response receiving an indication that the aerosol provision system is lost, using the database to predict a location of the aerosol provision system.

15. A computing device comprising:
one or more processors; and
memory configured to store instruction that, when executed by the one or more processors cause the one or more processors to perform a method comprising:
maintaining a database of locations an aerosol provision system has been lost and/or found; and
in response receiving an indication that the aerosol provision system is lost, using the database to predict a location of the aerosol provision system.
